(19) United States
(12) Patent Application Publication
(10) Pub. No.: US 2023/0073901 A1
(43) Pub. Date: Mar. 9, 2023

(54) SYSTEMS AND METHODS FOR PERFORMING MULTIPLE-WAVELENGTH QUANTITATIVE PHASE IMAGING (QPI)

(71) Applicant: Arizona Board of Regents on Behalf of the University of Arizona, Tucson, AZ (US)

(72) Inventor: Thomas D. Milster, Tucson, AZ (US)

(21) Appl. No.: 17/796,756

(22) PCT Filed: Feb. 1, 2021
(86) PCT No.: PCT/US2021/016101

§ 371 Date: Aug. 1, 2022

Related U.S. Application Data
(60) Provisional application No. 62/969,055, filed on Feb. 1, 2020.

(51) Int. Cl. G02B 21/14; G02B 21/00

(52) U.S. Cl. CPC G02B 21/14; G02B 21/0056

(57) ABSTRACT

The present disclosure is directed to systems and methods for performing multiwavelength quantitative phase imaging (QPI). The QPI systems and methods are well suited for imaging biological cells. For example, the QPI system can have a relatively simple configuration and can be employed with microscopes for analyzing biological cells without having to modify the hardware (e.g., the auxiliary image pathway) of the microscope. In addition, the QPI systems and methods can be used for other applications, such as lens testing and atmospheric correction of images captured by cell phone cameras, for example.

### CROSS-REFERENCE TO RELATED APPLICATIONS

This application is a nonprovisional Patent Cooperation Treaty (PCT) application that claims priority to, and the benefit of the filing date of, U.S. Provisional Application having Ser. No. 62/969,055, filed on Feb. 1, 2020 and entitled “SYSTEMS AND METHODS FOR PERFORMING MULTIPLE-WAVELENGTH QUANTITATIVE PHASE IMAGING (QPI),” which is incorporated by reference herein in its entirety.

### TECHNICAL FIELD

The present disclosure is directed to quantitative phase imaging (QPI), and more particularly, to methods and systems for performing multiple (multi)-wavelength QPI that are well suited for imaging biological cells and other applications, such as lens testing and atmospheric correction of images captured by cell phone cameras, for example.

### BACKGROUND

Quantitative phase imaging (QPI) techniques for mapping phase distribution continue to expand, offering information about the complex optical field (amplitude and phase) in the image plane. Shifts in optical path length of a sample are mapped to form the measured image, which contains information about the thickness and refractive index of the sample. QPI techniques allow for a variety of applications, particularly in biology, including imaging of red blood cells, optical properties of tissues, label-free in vitro biological sample imaging, and cell refractive index.

Measurement of the multi-spectral refractive index of cells is a growing topic of interest in the biological and medical fields. In biological cells and fluids, the refractive index provides a characteristic marker of individual materials, governing how the tissue interacts with electromagnetic radiation. Direct measurement of the refractive index has the potential to differentiate healthy from pathologic tissue, leading to novel methods for cancer detection and diagnosis. The refractive index marker has been used for tracking the development of diabetes by examining the glycation process and glycated proteins. Additionally, other optical diagnostic technologies make use of spectral light sources to analyze tissue properties in the visible and near-infrared (NIR) regions.

Typical quantitative techniques that can recover the phase delay caused by the sample make use of coherent illumination interferometry, creating expensive and highly sensitive systems. Most QPI techniques require the use of multiple images to retrieve complex optical field information. A common example of this method is Differential Phase Contrast (DPC). In this partially coherent QPI technique, the amplitude and phase are recovered from the Fourier asymmetry and a single-step deconvolution.

Several of the QPI techniques recently developed are single-shot methods, requiring only one image taken by an RGB camera to capture the white-light illuminated sample. An early example of a single-shot QPI method is Instantaneous Spatial Light Interference Microscopy (iSLIM), which allows for spatially and temporally sensitive optical path length measurements, provides phase dispersion imaging, and multiplexes with fluorescence imaging. These QPI systems typically require modifications to the internal portions of the microscope or require modification and/or addition of hardware elements in an axillary image path.

A need exists for a multi-wavelength QPI system that has a relatively simple configuration and that can be employed with microscopes without having to modify the internal hardware of the microscope.

### SUMMARY

The present disclosure discloses QPI systems and methods. In accordance with an embodiment, a QPI system is provided for imaging a biological sample. The QPI system of this embodiment comprises an optics system, a sample holder, a multi-wavelength light source, an optically transmissive substrate, a lens, a multi-wavelength image sensor array, and a processor. the optics system has at least first and second optical ports. The sample holder is positioned in a preselected position and orientation relative to the first optical port and has a biological sample disposed thereon. The multi-wavelength light source is configured to emit multiple wavelengths of light and is positioned relative to the first optical port to ensure that at least a portion of the emitted light of multiple wavelengths is transmitted through the biological sample disposed on the sample holder. Light transmitted though the biological sample is directed by the optics system out of the second optical port. The optically transmissive substrate is positioned relative to the second optical port to ensure that light passing out of the second optical port is incident on a structure formed in the optically transmissive substrate. The structure comprises at least one of a computer generated hologram (CGH) and a diffractive grating. Light passing out of the second optical port is incident on the structure, which generates at least one respective phasorgram image for each respective wavelength of light. The lens is positioned in a preselected position relative to the optically transmissive substrate. The multi-wavelength image sensor array, the lens and the multi-wavelength image sensor array are positioned relative to one another to ensure that the phasorgram images are directed by the lens onto the multi-wavelength image sensor array, which converts the phasorgram images into electrical signals representing the phasorgram images. The processor is configured to perform a reconstruction algorithm that processes the electrical signals representing the phasorgram images to obtain a phase distribution estimate of the light transmitted through the biological sample.

In accordance with an embodiment, the optics system is an optics system of a microscope.

In accordance with an embodiment, at least the multi-wavelength light source and the sample holder are coupled together in a first device that is adapted to be attached to the microscope in alignment with the first optical port.

In accordance with an embodiment, the optically transmissive substrate and the lens are coupled together in a second device that is adapted to be attached to the microscope in alignment with the second optical port.

In accordance with an embodiment, the optically transmissive substrate, the lens and the multi-wavelength image sensor array are coupled together in a second device that is adapted to be attached to the microscope in alignment with the second optical port.

In accordance with an embodiment, the multi-wavelength image sensor array is inside of a red-green-blue (RGB) camera.

In accordance with an embodiment, the reconstruction algorithm comprises an iterative Fourier algorithm with field averaging.

In accordance with an embodiment, the reconstruction algorithm is performed for each of the wavelengths of light on the respective phasorgram images associated with the respective wavelengths of light, and each reconstruction algorithm comprises the steps of:

dividing one of the phasorgram images into N phasorgram subareas, where Nis a positive integer that is greater than or equal to one;

multiplying a complex transmission of N effective filters by an initial estimate of an extrinsic phase distribution to obtain N pupil fields;

performing a Fourier transformation algorithm on the N pupil fields to generate N complex fields on an image plane;

applying an amplitude constraint that replaces N calculated amplitudes of the N complex fields with N amplitudes of the N phasorgram subareas, respectively, to generate N amplitude-constrained complex fields;

performing an inverse Fourier transformation on the N amplitude-constrained complex fields to transform the N amplitude-constrained complex fields into N complex pupil fields;

dividing the N complex pupil fields by the N effective filters to obtain N estimates, respectively, of an extrinsic phase distribution associated with the light transmitted through the biological sample;

averaging at least a subset of the N estimates to obtain an estimate for a current iteration of the reconstruction algorithm of the extrinsic phase distribution associated with the light transmitted through the biological sample; and

reiterating the steps of the reconstruction algorithm until convergence of the reconstruction algorithm occurs, wherein a final estimate of the extrinsic phase distribution associated with the light transmitted through the biological sample is obtained when convergence is reached.

In accordance with an embodiment, the reconstruction algorithm further comprises:

prior to dividing one of the phasorgram images into N phasorgram subareas, performing a spectral filtering algorithm that uses the phasorgram images associated with the other wavelengths of light to obtain a spectrally-filter phasorgram image, and wherein the step of dividing one of the phasorgram images into N phasorgram subareas comprises dividing the spectrally-filtered phasorgram image into N phasorgram subareas.

In accordance with an embodiment, the reconstruction algorithm further comprises:

after averaging said at least a subset of the N estimates to obtain an estimate for a current iteration of the reconstruction algorithm of the extrinsic phase distribution associated with the light transmitted through the biological sample, and prior to reiterating the steps of the reconstruction algorithm until convergence, performing a spectral filtering algorithm that uses the estimate of the extrinsic phase distribution for the current iteration obtained by the other reconstruction algorithms being performed in parallel to obtain a spectrally-filtered estimate for the current iteration of the reconstruction algorithm of the extrinsic phase distribution associated with the light transmitted through the biological sample.

The phase distribution estimate contains information about a refractive index of the biological sample. In accordance with an embodiment, the processor processes the refractive index to produce a marker that is characteristic of one or more materials comprising the biological sample and of how tissue of the sample interacts with electromagnetic radiation.

In accordance with an embodiment, the marker is used to differentiate healthy from pathologic tissue.

In accordance with an embodiment, the marker is used for cancer detection and diagnosis.

In accordance with an embodiment, the marker is used to track a development of diabetes.

In accordance with an embodiment, the QPI system is used for testing lenses and comprises a multi-wavelength light source, an optically transmissive substrate, a multi-wavelength image sensor array and a processor. The optically transmissive substrate is positioned relative to the light source to ensure that light emitted by the light source is incident on a structure formed in the optically transmissive substrate. The structure comprises at least one of a CGH and a diffractive grating and generates at least one respective phasorgram image for each respective wavelength of light. A lens under test is positioned in a preselected position relative to the optically transmissive substrate. The multi-wavelength image sensor array, the lens under test and the multi-wavelength image sensor array are positioned relative to one another to ensure that the phasorgram images are directed by the lens under test onto the multi-wavelength image sensor array which converts the phasorgram images into electrical signals representing the phasorgram images. A processor is configured to perform a reconstruction algorithm that processes the electrical signals representing the phasorgram images to obtain a phase distribution estimate of the light transmitted through the lens under test.

In accordance with an embodiment, the reconstruction algorithm performed for lens testing is performed for each of the wavelengths of light on the respective phasorgram images associated with the respective wavelengths of light and comprises steps of:

dividing one of the phasorgram images into N phasorgram subareas, where N is a positive integer that is greater than or equal to one;

multiplying a complex transmission of N effective filters by an initial estimate of an extrinsic phase distribution to obtain N pupil fields;

performing a Fourier transformation algorithm on the N pupil fields to generate N complex fields on an image plane;

applying an amplitude constraint that replaces N calculated amplitudes of the N complex fields with N amplitudes of the N phasorgram subareas, respectively, to generate N amplitude-constrained complex fields;

performing an inverse Fourier transformation on the N amplitude-constrained complex fields to transform the N amplitude-constrained complex fields into N complex pupil fields;

dividing the N complex pupil fields by the N effective filters to obtain N estimates, respectively, of an extrinsic phase distribution associated with the light transmitted through the biological sample;

averaging at least a subset of the N estimates to obtain an estimate for a current iteration of the reconstruction algorithm of the extrinsic phase distribution associated with the light transmitted through the biological sample; and

reiterating the steps of the reconstruction algorithm until convergence of the reconstruction algorithm occurs, wherein a final estimate of the extrinsic phase distribution associated with the light transmitted through the biological sample is obtained when convergence is reached.

In accordance with an embodiment, the reconstruction algorithm performed for lens testing further comprises:

prior to dividing one of the phasorgram images into N phasorgram subareas, performing a spectral filtering algorithm that uses the phasorgram images associated with the other wavelengths of light to obtain a spectrally-filter phasorgram image, and wherein the step of dividing one of the phasorgram images into N phasorgram subareas comprises dividing the spectrally-filtered phasorgram image into N phasorgram subareas.

In accordance with an embodiment, the reconstruction algorithm performed for lens testing further comprises:

after averaging said at least a subset of the N estimates to obtain an estimate for a current iteration of the reconstruction algorithm of the extrinsic phase distribution associated with the light transmitted through the biological sample, and prior to reiterating the steps of the reconstruction algorithm until convergence, performing a spectral filtering algorithm that uses the estimate of the extrinsic phase distribution for the current iteration obtained by the other reconstruction algorithms being performed in parallel to obtain a spectrally-filtered estimate for the current iteration of the reconstruction algorithm of the extrinsic phase distribution associated with the light transmitted through the biological sample.

In accordance with an embodiment, the QPI system is used for correcting images captured by a camera module of a mobile device for atmospheric aberration. The QPI system comprises an adapter, a lens of the mobile device, a multi-wavelength image sensor of the mobile device, and a processor of the mobile device. The adapter is configured to be mechanically coupled to the mobile device in optical alignment with the lens of the mobile device. The adapter comprises a multi-wavelength light source configured to emit multiple wavelengths of light, and an optically transmissive substrate positioned relative to the light source to ensure that light emitted by the light source is incident on a structure formed in the optically transmissive substrate. The structure comprises at least one of a CGH and a diffractive grating. The structure generates at least one respective phasorgram image for each respective wavelength of light. The lens of the mobile device directs the phasorgram images onto a multi-wavelength image sensor array of the mobile device, which converts the phasorgram images into electrical signals representing the phasorgram images. The processor of the mobile device is configured to perform a reconstruction algorithm that processes the electrical signals representing the phasorgram images to obtain a phase distribution estimate of the light transmitted through the lens. The processor is configured to perform an atmospheric aberration correction algorithm that uses the phase distribution estimate to correct images captured by other camera modules of the mobile device to correct for atmospheric aberration in the captured images.

In accordance with an embodiment of the QPI system for correcting atmospheric aberration, the multi-wavelength light source comprises a combination of a natural light source and a plurality of filters that operate on natural light from the natural light source to produce the light of multiple wavelengths.

In accordance with another representative embodiment, the phasorgram images for each respective wavelength are captured by the multi-wavelength image sensor array in a single-shot acquisition.

In accordance with another representative embodiment, the multi-wavelength light source comprises at least one of (1) a combination of a natural light source and a plurality of filters that operate on natural light from the natural light source to produce the light of multiple wavelengths and (2) a microscope illumination lamp.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a block diagram of the QPI system in accordance with a representative embodiment that performs single-shot QPI acquisition.

FIG. 2 shows a binary CGH that may be used as the CGH in the QPI system shown in FIG. 1.

FIGS. 3A-3C show examples of multiple, spatially-separated phasorgram images acquired in the blue, green and red wavelengths, respectively, by the camera of the system shown in FIG. 1.

FIG. 4 demonstrates the concept of complex diversity employed in the methods of the present disclosure.

FIG. 5 shows the processes for designing the CGH and performing reconstruction in accordance with a representative embodiment.

FIG. 6 is a block diagram of processing logic for carrying out the iterative operations shown in block 503 of FIG. 5.

FIG. 7 is a flow diagram that represents the QPI method in accordance with a representative embodiment.

FIG. 8 shows a camera lens testing application in accordance with an embodiment, where the camera lens under test replaces the FT lens shown in FIG. 1.

FIG. 9 is a conceptual drawing of the pattern observed on the camera shown in FIG. 1 using the QPI system and method described with reference to FIGS. 1-7.

FIG. 10 is a drawing of the QPI system in accordance with a representative embodiment in which the light of different wavelengths is directed onto the CGH from different angles.

### DETAILED DESCRIPTION

The present disclosure is directed to systems and methods for performing multi-wavelength QPI that are well suited for imaging of biological cells and other applications, such as lens testing and atmospheric correction in cell phone cameras. The multi-wavelength QPI system can have a relatively simple configuration and can be employed with microscopes without having to modify the hardware (e.g., the auxiliary image pathway) of the microscope.

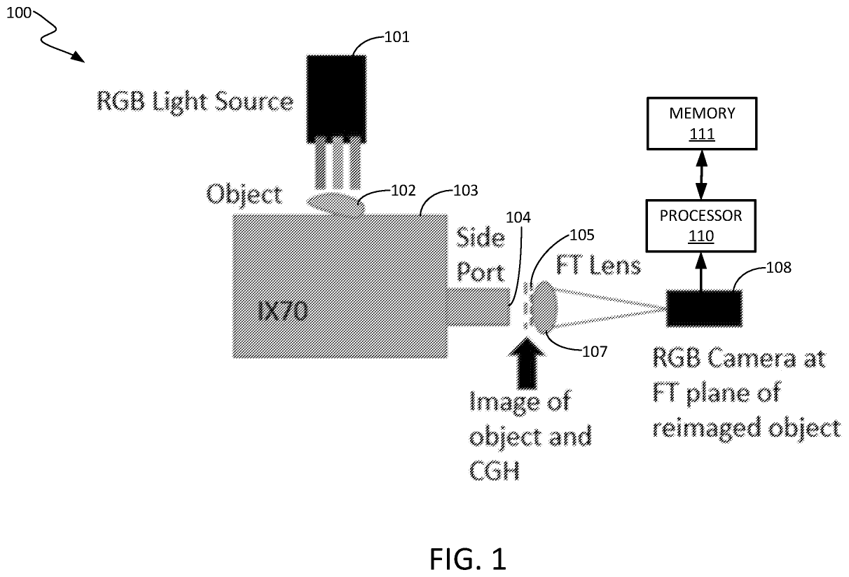

In accordance with a representative embodiment, multi-wavelength red-green-blue (RGB) quantitative information is acquired in a single image with a system having a relatively simple configuration, as will be described below in more detail with reference to FIG. 1. First, a collimated RGB light source of the system illuminates a biological sample positioned along an optical pathway of a microscope of the system in transmission, or transmissive mode. Next, the image is relayed along another optical pathway of the microscope (e.g., an auxiliary optical pathway) through an existing port of the microscope (e.g., a side port along the auxiliary optical pathway) to a plane containing a computer-generated hologram (CGH) of the system. Next, light transmitted through the CGH is focused with a Fourier transform (FT) lens of the system to an RGB camera of the system, which acquires a phasorgram image. A processor of the system then performs a complex diversity reconstruction algorithm that processes the phasorgram image to reconstruct a QPI image of the biological sample. A few representative embodiments of the systems and methods are described below with reference to the figures.

In the following detailed description, for purposes of explanation and not limitation, exemplary, or representative, embodiments disclosing specific details are set forth in order to provide a thorough understanding of inventive principles and concepts. However, it will be apparent to one of ordinary skill in the art having the benefit of the present disclosure that other embodiments according to the present teachings that are not explicitly described or shown herein are within the scope of the appended claims. Moreover, descriptions of well-known apparatuses and methods may be omitted so as not to obscure the description of the exemplary embodiments. Such methods and apparatuses are clearly within the scope of the present teachings, as will be understood by those of skill in the art. It should also be understood that the word “example,” as used herein, is intended to be non-exclusionary and non-limiting in nature.

The terminology used herein is for purposes of describing particular embodiments only and is not intended to be limiting. Any defined terms are in addition to the technical, scientific, or ordinary meanings of the defined terms as commonly understood and accepted in the relevant context.

The terms “a,” “an” and “the” include both singular and plural referents, unless the context clearly dictates otherwise. Thus, for example, “a device” includes one device and plural devices. The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art. Relative terms, such as “in,” “out,” “over,” “above,” “below,” “top,” bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

Relative terms may be used to describe the various elements' relationships to one another, as illustrated in the accompanying drawings. These relative terms are intended to encompass different orientations of the device and/or elements in addition to the orientation depicted in the drawings. Unless, otherwise stated herein, elements or components that are referred to as being “connected to” or “coupled to” one another may be directly connected or coupled to one another or indirectly connected or coupled to one another through an intervening element, component, device or structure.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “processor,” “processing device,” or “processing logic,” as those terms are used herein, encompass an electronic component that is able to execute computer instructions. References herein to a system comprising “a processor,” “a processing device,” or “processing logic” should be interpreted as a system having one or more processors, processing devices or instances of processing logic. A processor may be, for example, a multi-core processor. A processor may also refer to a collection of processors within a single computer system or distributed amongst multiple computer systems. The term “computer,” as that term is used herein, should be interpreted as possibly referring to a single computer or computing device or to a collection or network of computers (e.g., cloud computing), each comprising a processor or processors. Instructions of a computer program can be performed by a single computer or processor or by multiple processors that may be within the same computer or distributed across multiple computers.

FIG. 1 is a block diagram of the QPI system 100 in accordance with a representative embodiment that performs single-shot QPI acquisition. A collimated RGB light source 101 illuminates a biological sample 102 positioned along an optical pathway of a microscope 103. The cellular structure of the biological sample 102 weakly modifies the phase across its image, which is a standard requirement for QPI imaging. The transmitted image is relayed along another optical pathway of the microscope (e.g., an auxiliary optical pathway) through an existing port 104 of the microscope 103 (e.g., a side port along the auxiliary optical pathway) to a plane containing a CGH 105. In an experimental setup, an Olympus IX70n microscope was used in the system 100. This particular microscope has a convenient side port that can be used for this purpose. In most scientific-grade microscopes, an equivalent auxiliary imaging path is available. It should be noted that the inventive principles and concepts are not limited with respect to the type of microscope that is used for this purpose. It should also be noted that although one of the goals discussed herein is to avoid having to modify any hardware of the microscope to perform the QPI method disclosed herein, the inventive principles and concepts equally apply to microscopes having hardware that is modified to perform the methods described herein.

Light transmitted through the CGH 105 is focused with a FT lens 107 onto an RGB camera 108, which acquires a phasorgram image. A processor 110 of the system then performs a complex diversity reconstruction algorithm that processes the phasorgram image to reconstruct a QPI image of the biological sample. Memory 111 of the system 100 is in communication with the processor 110 and stores data and/or computer instructions executed by the processor 110.

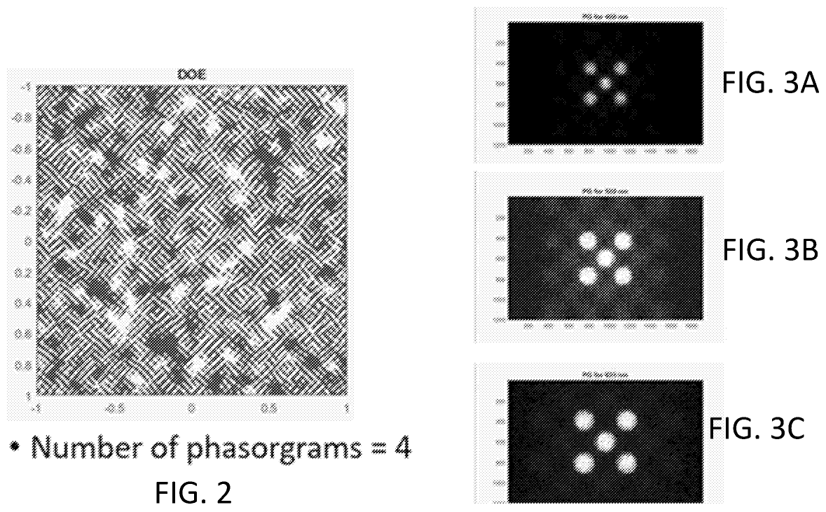

The CGH 105 is designed to produce multiple focus points that are spatially separated in the phasorgram, where each focus point is disturbed with a known amount of random perturbation. FIG. 2 shows an example of a binary CGH that may be used as the CGH 105 and FIGS. 3A-3C show multiple, spatially-separated phasorgram images acquired in the blue, green and red wavelengths, respectively. The CGH 105 distributes information to the RGB camera 108 in such a way that multiple spatially-separated phasorgram images are acquired for the multi-wavelength band. The example of the binary CGH shown in FIG. 2 has only two depths when implemented in an optically transparent structure and is relatively simple to fabricate with direct etching into glass or with replication technology in glass or plastic, for example. Alternatives for CGH design can include multiple-step or grayscale surface profiles, which increase light efficiency. Also, a diffractive grating can be used instead of or in addition to a CGH.

The processor 110 performs a complex diversity reconstruction algorithm that processes the phasorgram images for the three different wavelengths shown in FIGS. 3A-3C to reconstruct a QPI image of the biological sample. With “single-shot” acquisition, as depicted in FIG. 1, multiple irradiance data are obtained by the CGH 105, which alternatively may be or include a diffractive grating. For ease of discussion, it will be assumed that the CGH 105 is used in the system 100. The CGH 105 is designed to generate multiple diffraction orders with different diversity values. During the CGH design process, effective filters associated with the individual diffraction orders from the CGH 105 are calculated. The effective filters can be extracted by numerical propagation, and they preferably include both real and imaginary values, which signify both absorption and phase shift versus position in the filter plane. The reconstruction algorithm uses accurate knowledge of the effective filters for each diffraction order to achieve high-quality reconstruction of the extrinsic phase, which in the microscope application is the phase distribution of light transmitted through the cell. This is in contrast to the common practice of specifying only the phase portion of the filter. This approach of the present disclosure is referred to herein as “complex diversity.” A modified classical Fourier iterative algorithm preferably is used for reconstruction of the extrinsic aberration in order to avoid noise amplification due to small amplitudes of the effective filters.

The single-shot imaging technique overcomes drawbacks of conventional imaging techniques by capturing multiple images generated by the CGH 105 in a single acquisition. However, the discussion below shows that there are special considerations in the design of the system and the reconstruction algorithm for single-shot techniques that have not, before now, been adequately addressed. The concept of complex diversity described in the present disclosure, and introduced in a previously-filed PCT application by the Applicant, application number PCT/US2020/042112, adequately accounts for these special considerations, where complex-number pupil filters containing both amplitude and phase values are extracted by numerical propagation from the CGH design.

### 1. Principle

### A. Concept of Complex Diversity

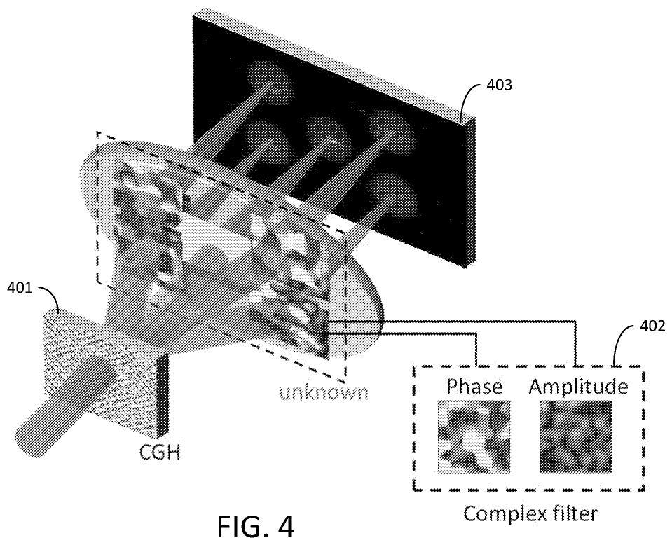

FIG. 4 demonstrates the concept of complex diversity. A CGH 401 generates multiple diffraction orders by employing different effective filters 402 that create multiple images at different positions on an image sensor 403. As indicated above, a diffractive grating may be used instead of or in combination with a CGH. By dividing the image, multiple phasorgrams are obtained from a single image acquisition. In conventional phase diversity reconstruction algorithms, phase filters corresponding to the phasorgrams are the same as the phase filters used to generate the phasorgrams. On the other hand, effective filters used for reconstruction in accordance with the inventive principles and concepts are not obvious in single-shot techniques, and they include both amplitude and phase information. The following sub-sections describe the design of the CGH, extraction of the effective filters of the CGH, and the complex diversity reconstruction algorithm in accordance with a representative embodiment.

### B. CGH Design

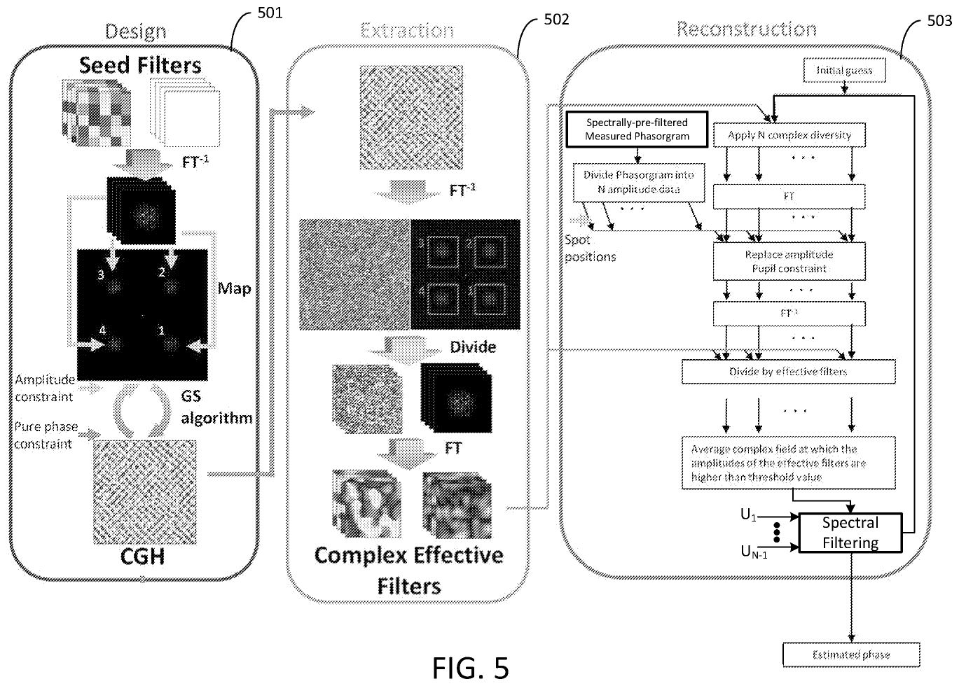

The design of the CGH 105 of the present disclosure in accordance with a representative embodiment comprises three processes, which are illustrated in FIG. 5. The first process, which is represented by the block labeled 501, is designing the CGH, which starts with setting up N seed filters that are proper for determining an extrinsic aberration, where N is a positive integer that is greater than or equal to one. In principle, arbitrary modulations can be used as the seed filters, but in accordance with this embodiment, random phase seed filters are selected because they show better performance for estimating Kolmogorov extrinsic disturbances than other forms of diversity. Especially for single-shot techniques, it is important to keep the dynamic range of signal values for all phasorgrams at nearly the same levels, because exposure time and incident light power cannot be adjusted for the individual phasorgrams. With random phase diversity, generated phasorgrams exhibit similar peak values, unlike defocus diversity.

During the first process 501, the seed filters are converted to complex field phasorgrams by taking the inverse Fast Fourier Transforms (IFFTs). Amplitudes of the complex fields of the N individual phasorgrams are mapped onto different positions in the image plane. This multiple-phasorgram amplitude distribution is the target amplitude for the CGH design. Conventional CGH design techniques, such as the Gerchberg-Saxton (GS) algorithm and the modified GS technique, for example, can be used for this design process. The constraints in the CGH design preferably include a pure phase constraint in the pupil plane and the amplitude target distribution in the image plane.

### C. Extraction of Effective Filters

The second process, represented by the block labeled 502, is an extraction of the N complex effective filters. Although the CGH generates the same amplitude patterns as generated from individual seed filters, the field modulations introduced into the diffraction orders are not the same as the seed filters when using the CGH because the CGH design process does not constrain these field modulations. Thus, in accordance with a representative embodiment, the actual effective filters are extracted from the designed CGH during the extraction process 502.

During the extraction process 502, the complex field reflected from the CGH pattern is calculated in a computer by assuming illumination with a uniform plane-wave amplitude. Then, the field is numerically propagated to the image plane by an performing an IFFT. The complex field at the image plane is divided into N individual subareas corresponding to the phasorgrams by cropping data in the image plane, which results in a collection of phasorgrams. The phasorgram fields from the cropped subareas are individually propagated back to the pupil plane by performing a FFT. The resulting collection of N complex field patterns in the pupil plane are the effective filters introduced to the individual diffraction orders.

It should be noted that the design process 501 and the extraction process 502 need only be performed one time when a new CGH (or diffractive grating) is generated. Thus, these additional process steps do not increase computational time for the reconstruction, represented by the block labeled 503.

### D. Reconstruction Algorithm

The third process 503 is reconstruction. The reconstruction process represented by block 503 is performed for each wavelength used in the multi-wavelength QPI system 100, but for ease of illustration and discussion, a single instance of the reconstruction algorithm is shown and described. The experimentally-measured phasorgram associated with one of the wavelengths formed by using the CGH in the manner described with reference to FIG. 1 is divided into N individual phasorgram subareas, which are used in the reconstruction. Prior to the division process, a spectral pre-filtering algorithm can be performed on the experimentally-measured phasorgram to reduce optical crosstalk from the other spectral channels of the RGB camera. Since RGB cameras have some crosstalk between spectral channels, spectrally pre-filtering the phasorgram can provide a cleaner starting point for the phase reconstruction algorithm. Therefore, it will be assumed herein that spectral pre-filtering is performed, although the pre-filtering step is not necessary, but preferred. In each instance of the reconstruction algorithm for each respective wavelength, the spectral pre-filtering algorithm utilizes the experimentally-measured phasorgrams captured for the other respective wavelengths.

In accordance with a representative embodiment, the reconstruction algorithm is an iterative Fourier method with field average proposed by Gerchberg, which is modified for complex diversity in accordance with the inventive principles and concepts. In accordance with this embodiment, the reconstruction algorithm starts with setting an initial guess in the pupil plane as a flat phase, i.e., no aberration. Then, the following steps proceed in an iterative manner as follows: (1) the effective filters obtained by the extraction process 502 are applied to the estimate of the extrinsic phase distribution (the initial guess in the first iteration) to yield N individual pupil fields by multiplying the complex transmission of the effective filters by the estimate of the extrinsic phase distribution; (2) FFTs generate N individual complex fields on the image plane; (3) an amplitude constraint preferably is applied by replacing the calculated amplitudes with the measured phasorgram set without disturbing the phase distribution; (4) inverse FFTs are applied to the N complex fields to propagate them back to the pupil plane; (5) the resulting complex pupil fields are divided by the effective filters in order to form N individual estimates of the extrinsic phase; (6) these N estimates are averaged to obtain the iteration's estimate of the extrinsic field, except in areas where amplitudes of the effective filters are smaller than a threshold value to avoid noise amplification. The threshold value may be set to, for example, 10% of the maximum amplitude, but other threshold values could be used.

In accordance with a preferred embodiment, the reconstruction algorithm includes a step (7), which is a spectral filtering algorithm on the iteration's estimate obtained by averaging the complex fields. In the spectral filtering algorithm, input from other spectral channels is used to define the estimate of complex-valued electric field Us passed to the algorithm, which are the current estimates of the extrinsic phase and amplitude at each wavelength. For example, if there are three wavelength channels (RGB), then there are three parallel reconstruction algorithms, with the phase estimates from the other spectral channels being used in the spectral filtering block.

The process from steps (1) to (6) or (1) to (7) is defined as one iteration, and iterations preferably are repeated until an error measure between the measured irradiance pattern and the synthetically generated pattern falls below a target threshold value, or the iteration number reaches a pre-determined maximum. The final estimates obtained after spectral filtering by all of the parallel reconstruction algorithms provide a QPI result that provides information associated with the biological sample 102.

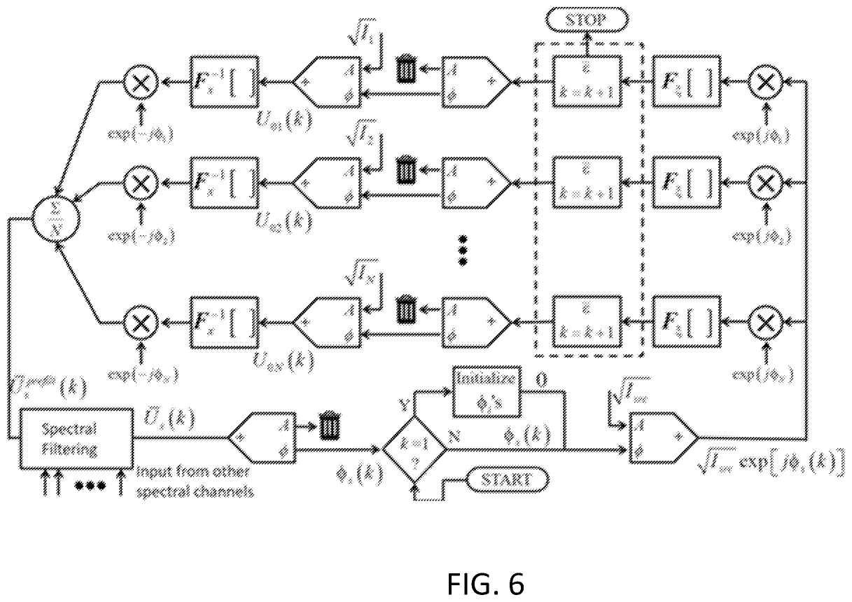

FIG. 6 is a block diagram showing processing logic for carrying out the iterative operations described above with reference to block 503 of FIG. 5. As indicated above, there would be a respective instance of the processing logic shown in FIG. 6 for each respective wavelength.

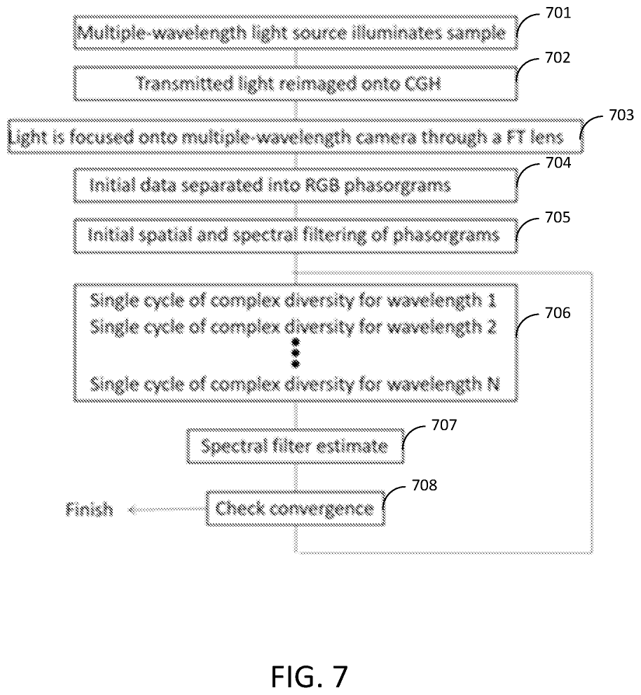

FIG. 7 is a flow diagram that represents the QPI method in accordance with a representative embodiment. At step 701, a multi-wavelength (e.g., RGB) light source illuminates the biological sample. At step 702, the image formed by the light transmitted through the sample is reimaged onto the CGH (and/or a diffractive grating). At step 703, the image formed by the CGH is coupled by the FT lens onto a multi-wavelength (e.g., RGB) camera, which forms the spatially-separated phasorgrams associated with the different wavelengths on the image plane of the camera, as indicated by block 704.

Steps 705-708 represent the reconstruction algorithms (performed per wavelength) performed by the processor 110, as described above with reference to block 503 of FIG. 5. In step 705, spatial and spectral pre-filtering is performed on the measured phasorgrams. Block 706 represents steps (1)-(6) described above with reference to block 503 of FIG. 5 iteratively performed. Step 707 corresponds to the spectral filtering algorithm of step (7) described above with reference to block 503 of FIG. 5. In step 708, a determination is made as to whether the reconstruction algorithm has converged. If not, the process represented by blocks 706-707 is reiterated until convergence has been reached. Typically, convergence is reached when the mean-square difference between the measured phasorgrams and the phasorgrams calculated from the reconstructed extrinsic phase passes below a pre-determined threshold value.

One of the benefits of the QPI system 100 shown in FIG. 1 is that the RGB light source 101 can be configured to mate with a sample holder that holds the biological sample 102, and the combined RGB light source/sample holder can be configured as an attachment adapted to be removably attached to an optical port of the microscope. Likewise, the combined CGH 105/FT lens 107/RGB camera 108 can be implemented as an attachment adapted to be removeably attached to an optical port of the microscope 103, such as the auxiliary port. The camera 108 could be separate from the attachment, but making it part of the attachment, or configuring the attachment to removably coupled to the camera, would ensure alignment between the FT lens 107, the CGH 105 and the camera 108. It should be noted that the multi-wavelength light source 101 can also be a standard microscope illumination lamp.

The processor 110 and memory 111 may be components of a computer system, such as, for example, a personal computer (PC) that can be electrically coupled via a wired or wireless link to the camera 108. The aforementioned attachments, if used, could be configured to attach to the respective ports in aligned positions via keying features on the attachments and the ports to ensure precise alignment along the optical pathways.

The final phase distribution estimate obtained at convergence of the reconstruction algorithm contains information about the thickness and refractive index of the biological sample. This information is useful for a variety of applications, particularly in biology, including imaging of red blood cells, optical properties of tissues, label-free in vitro biological sample imaging, and cell refractive index. In biological cells and fluids, the refractive index provides a characteristic marker of individual materials, governing how the tissue interacts with electromagnetic radiation. The information about the refractive index has the potential to be used to differentiate healthy from pathologic tissue, leading to novel methods for cancer detection and diagnosis. The refractive index marker has been used in the past for tracking the development of diabetes by examining the glycation process and glycated proteins.

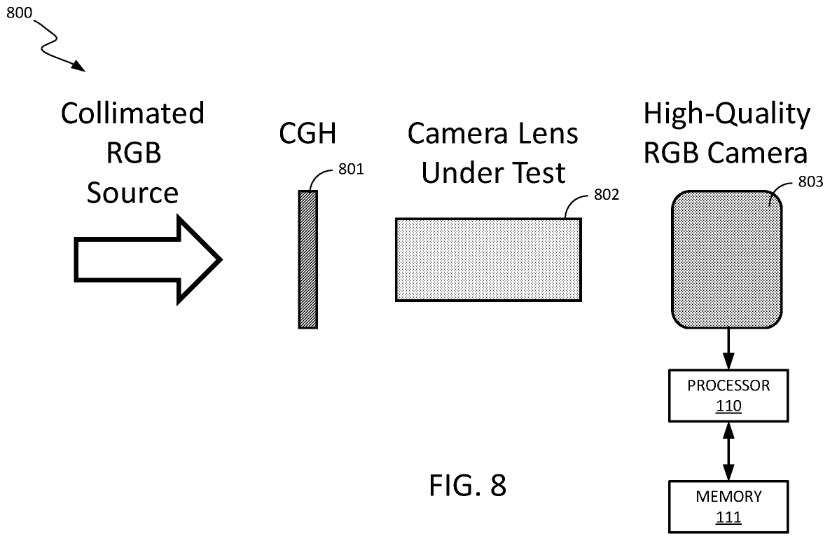

FIG. 8 shows a camera lens testing application in accordance with an embodiment, where the camera lens under test 802 replaces the FT lens 107 shown in FIG. 1. The method described above with reference to FIG. 7 is used by the system 800. The collimated RGB source preferably is, as with the microscope 103 shown in FIG. 1, a high-quality multi-wavelength light source. Instead of measuring phase transmitted through a biological sample, however, the system 800 measures the phase transmitted through the camera lens under test 802. If the camera lens under test 802 is of high quality, the phase will be nearly flat. The importance of any deviations from a flat wavefront will indicate manufacturing or design errors of the lens under test 802, which is useful feedback for the lens manufacturer in terms of design and process control. Additionally, the system 800 can be used by lens manufacturers, such as in cell-phone manufacturer locations, for example, to serve as a quality control device for purchased lenses. Because the system 800 is fast and can be made relatively inexpensively, it can greatly increase the statistical process control capability in manufacturing and reduce the cost of quality control related to receiving purchased items.

Alternatively, the cell-phone camera image sensor can be used in place of the high-quality RGB camera 108. In this case, the cell phone with a simple CGH adaptor and filter can be used as a single instrument for detecting phase of an incoming wavefront at multiple wavelengths, which is useful for correction of atmospheric aberrations that distort images, like what is observed imaging scenes across a hot, sandy beach. That is, the addition of a simple CGH/filter adaptor can be used in the cell phone camera system to correct images from other camera modules in the system. Typically, modern cell phone cameras have multiple cameras for wide-angle, telephoto, and normal viewing, as well as time-of-flight information. The additional camera module could be used for atmospheric correction.

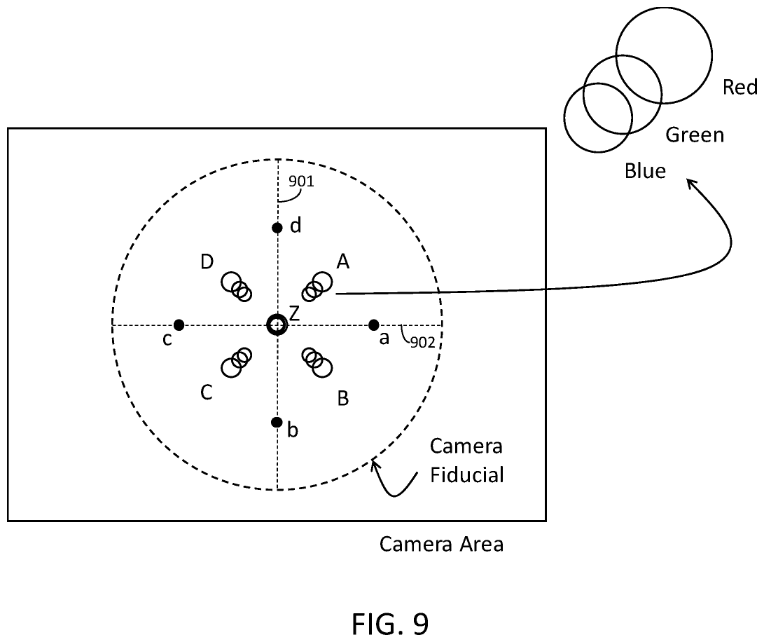

FIG. 9 is a conceptual drawing of the pattern observed on the camera using the QPI system and method described above with reference to FIGS. 1-7. The CGH 105 creates at least two diffracted orders, and this drawing illustrates a design using five diffracted orders. The diffracted orders are labeled as A, B, C, D and Z. Orders A, B, C and D are displaced in quadrants relative to the zero order, which is labeled Z. Depending on the wavelength, the orders change their spatial scale. As shown with RGB wavelengths, the red (R) wavelength diffracted orders are displaced farther from Z than the green (G) or blue (B) orders. The scaling is proportional to the source wavelength. Since the zero order does not change position on the camera with wavelength, it is stationary in the center of the pattern.

The A, B, C and D orders are separated and processed in the computer algorithm used to reconstruct the phase of the object. Depending on the manner in which the reconstruction algorithm is designed and implemented, diffracted orders may or may not be used. For example, since RGB information is separated spatially in the A, B, C and D orders, this information may be used and the Z order not used. In addition, the CGH may form additional diffracted orders that may or may not be used in the reconstruction algorithm.

Also shown in the drawing is a dashed line that represents a software fiducial that is a common feature of commercially available camera viewing software. A fiducial of this type is useful in aligning the CGH 105 with the camera 108. For example, the Z-order information focused from the CGH 105 can be used with a mechanical stage that controls the position of the camera in order to align the camera so that the Z order is in the center of the camera area. All diffraction orders move together, so the entire pattern is centered when the Z order is centered.

The CGH 105 can also have simple gratings or other diffractive features to aid in the alignment of the CGH 105 and the camera 108. For example, diffracted orders a, b, c, and d result from a simple linear grating that is designed into a region outside the CGH 105 used for the phase reconstruction. In other words, in the optically transmissive substrate in which the CGH is formed, a simple grating may be formed in a region of the substrate outside of the region in which the CGH is formed. These orders provide a reference for rotation of the CGH 105 with respect to the camera face. As with centering the Z order described above, rotation of the CGH 105 to align a, b, c and d with the vertical and horizontal lines 901 and 902, respectively, of the fiducial also rotates the CGH orders used for image processing. Thus, with the combination of x and y translation of the camera 108 and rotation of the CGH 105 using a fiducial and the reference grating orders, the system is aligned easily.

In addition to the CGH 105 that is used to produce phasorgrams for the computer algorithm, a second CGH can be designed without random phase changes in order initially to find the centers of diffracted orders on the camera. That is, the second CGH forms point foci at centers of the A, B, C and D circles. These foci are used to determine the centers of the phasorgram circles from the first CGH, which is information that is useful for the portion of the computer algorithm that divides the image from the first CGH into separate phasorgrams. Like with the first CGH 105, the second CGH can contain alignment features, like gratings, in order to align the second CGH with the camera.

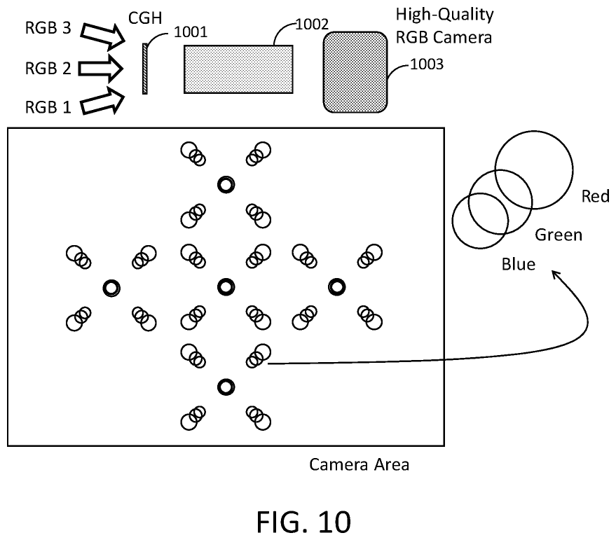

An extension of the methods described above uses multiple input beams coupled onto the CGH at different angles. FIG. 10 is a drawing of the QPI system in accordance with a representative embodiment in which the light of different wavelengths is directed onto the CGH from different angles. Each angled beam incident onto the CGH 1001 produces a shifted phasorgram on the image area of the camera 1003. Only the A, B, C, D and Z orders are shown in this figure, which illustrates five RGB beams illuminating the CGH. The additional beams provide information about the phase being reconstructed. In the microscope application, the additional information can be used to ptychgrahically fill Fourier space that increases resolution of the image. For the application described above for evaluating a camera lens under test 1002, the beams provide additional field angles that evaluate the lens at other regions of the camera area.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

What is claimed is:

1. A quantitative phase imaging (QPI) system for imaging a biological sample, the QPI system comprising:
an optics system having at least first and second optical ports;
a sample holder positioned in a preselected position and orientation relative to the first optical port, a biological sample being disposed on the sample holder;
a multi-wavelength light source configured to emit multiple wavelengths of light, the multi-wavelength light source being positioned relative to the first optical port to ensure that at least a portion of the emitted light of multiple wavelengths is transmitted through the biological sample held on the sample holder, wherein light transmitted though the biological sample is directed by the optics system out of the second optical port;
an optically transmissive substrate positioned relative to the second optical port to ensure that light passing out of the second optical port is incident on a structure formed in the optically transmissive substrate, the structure comprising at least one of a computer generated hologram (CGH) and a diffractive grating, wherein light passing out of the second optical port is incident on the structure, the structure generating at least one respective phasorgram image for each respective wavelength of light;
a lens positioned in a preselected position relative to the optically transmissive substrate;
a multi-wavelength image sensor array, the lens and the multi-wavelength image sensor array being positioned relative to one another to ensure that the phasorgram images are directed by the lens onto the multi-wavelength image sensor array, the multi-wavelength image sensor array converting the phasorgram images into electrical signals representing the phasorgram images; and
a processor configured to perform a reconstruction algorithm that processes the electrical signals representing the phasorgram images to obtain a phase distribution estimate of the light transmitted through the biological sample.

2. The QPI system of claim 1, wherein the optics system is an optics system of a microscope.

3. The QPI system of claim 2, wherein at least the multi-wavelength light source and the sample holder are coupled together in a first device that is adapted to be attached to the microscope in alignment with the first optical port.

4. The QPI system of claim 2, wherein the optically transmissive substrate and the lens are coupled together in a second device that is adapted to be attached to the microscope in alignment with the second optical port.

5. The QPI system of claim 2, wherein the optically transmissive substrate, the lens and the multi-wavelength image sensor array are coupled together in a second device that is adapted to be attached to the microscope in alignment with the second optical port.

6. The QPI system of claim 2, wherein the multi-wavelength image sensor array is inside of a red-green-blue (RGB) camera.

7. The QPI system of claim 1, wherein the reconstruction algorithm comprises an iterative Fourier algorithm with field averaging.

8. The QPI system of claim 1, wherein said at least one respective phasorgram image for each respective wavelength are captured by the multi-wavelength image sensor array in a single-shot acquisition.

9. The QPI system of claim 7, wherein the reconstruction algorithm is performed for each of the wavelengths of light on the respective phasorgram images associated with the respective wavelengths of light, and wherein each reconstruction algorithm comprises steps of:
dividing one of the phasorgram images into N phasorgram subareas, where N is a positive integer that is greater than or equal to one;
multiplying a complex transmission of N effective filters by an initial estimate of an extrinsic phase distribution to obtain N pupil fields;
performing a Fourier transformation algorithm on the N pupil fields to generate N complex fields on an image plane;
applying an amplitude constraint that replaces N calculated amplitudes of the N complex fields with N amplitudes of the N phasorgram subareas, respectively, to generate N amplitude-constrained complex fields;
performing an inverse Fourier transformation on the N amplitude-constrained complex fields to transform the N amplitude-constrained complex fields into N complex pupil fields;
dividing the N complex pupil fields by the N effective filters to obtain N estimates, respectively, of an extrinsic phase distribution associated with the light transmitted through the biological sample;
averaging at least a subset of the N estimates to obtain an estimate for a current iteration of the reconstruction algorithm of the extrinsic phase distribution associated with the light transmitted through the biological sample; and
reiterating the steps of the reconstruction algorithm until convergence of the reconstruction algorithm occurs, wherein a final estimate of the extrinsic phase distribution associated with the light transmitted through the biological sample is obtained when convergence is reached.

10. The QPI system of claim 9, wherein the reconstruction algorithm further comprises:
prior to dividing one of the phasorgram images into N phasorgram subareas, performing a spectral filtering algorithm that uses the phasorgram images associated with the other wavelengths of light to obtain a spectrally-filter phasorgram image, and wherein the step of dividing one of the phasorgram images into N phasorgram subareas comprises dividing the spectrally-filtered phasorgram image into N phasorgram subareas.

11. The QPI system of claim 9, wherein the reconstruction algorithm further comprises:
after averaging said at least a subset of the N estimates to obtain an estimate for a current iteration of the reconstruction algorithm of the extrinsic phase distribution associated with the light transmitted through the biological sample, and prior to reiterating the steps of the reconstruction algorithm until convergence, performing a spectral filtering algorithm that uses the estimate of the extrinsic phase distribution for the current iteration obtained by the other reconstruction algorithms being performed in parallel to obtain a spectrally-filtered estimate for the current iteration of the reconstruction algorithm of the extrinsic phase distribution associated with the light transmitted through the biological sample.

12. The QPI system of claim 1, wherein the phase distribution estimate contains information about a refractive index of the biological sample, and wherein the processor processes the refractive index to produce a marker that is characteristic of one or more materials comprising the biological sample and of how tissue of the sample interacts with electromagnetic radiation.

13. The QPI system of claim 12, wherein the marker can be used for at least one of (1) differentiating healthy from pathologic tissue, (2) cancer detection and diagnosis, and (3) to track a development of diabetes.

14. A quantitative phase imaging (QPI) system for testing lenses, the QPI system comprising:
a multi-wavelength light source configured to emit multiple wavelengths of light;
an optically transmissive substrate positioned relative to the light source to ensure that light emitted by the light source is incident on a structure formed in the optically transmissive substrate, the structure comprising at least one of a computer generated hologram (CGH) and a diffractive grating, the structure generating at least one respective phasorgram image for each respective wavelength of light, wherein a lens under test is positioned in a preselected position relative to the optically transmissive substrate;
a multi-wavelength image sensor array, the lens under test and the multi-wavelength image sensor array being positioned relative to one another to ensure that the phasorgram images are directed by the lens under test onto the multi-wavelength image sensor array, the multi-wavelength image sensor array converting the phasorgram images into electrical signals representing the phasorgram images; and
a processor configured to perform a reconstruction algorithm that processes the electrical signals representing the phasorgram images to obtain a phase distribution estimate of the light transmitted through the lens under test.

15. The QPI system of claim 14, wherein the reconstruction algorithm is performed for each of the wavelengths of light on the respective phasorgram images associated with the respective wavelengths of light, the reconstruction algorithms being performed in parallel, and wherein each reconstruction algorithm comprises steps of:
dividing one of the phasorgram images into N phasorgram subareas, where N is a positive integer that is greater than or equal to one;
multiplying a complex transmission of N effective filters by an initial estimate of an extrinsic phase distribution to obtain N pupil fields;
performing a Fourier transformation algorithm on the N pupil fields to generate N complex fields on an image plane;
applying an amplitude constraint that replaces N calculated amplitudes of the N complex fields with N amplitudes of the N phasorgram subareas, respectively, to generate N amplitude-constrained complex fields;
performing an inverse Fourier transformation on the N amplitude-constrained complex fields to transform the N amplitude-constrained complex fields into N complex pupil fields;
dividing the N complex pupil fields by the N effective filters to obtain N estimates, respectively, of an extrinsic phase distribution associated with the light transmitted through the biological sample;
averaging at least a subset of the N estimates to obtain an estimate for a current iteration of the reconstruction algorithm of the extrinsic phase distribution associated with the light transmitted through the biological sample; and
reiterating the steps of the reconstruction algorithm until convergence of the reconstruction algorithm occurs, wherein a final estimate of the extrinsic phase distribution associated with the light transmitted through the biological sample is obtained when convergence is reached.

16. The QPI system of claim 15, wherein the reconstruction algorithm further comprises:
prior to dividing one of the phasorgram images into N phasorgram subareas, performing a spectral filtering algorithm that uses the phasorgram images associated with the other wavelengths of light to obtain a spectrally-filter phasorgram image, and wherein the step of dividing one of the phasorgram images into N phasorgram subareas comprises dividing the spectrally-filtered phasorgram image into N phasorgram subareas.

17. The QPI system of claim 15, wherein the reconstruction algorithm further comprises:
after averaging said at least a subset of the N estimates to obtain an estimate for a current iteration of the reconstruction algorithm of the extrinsic phase distribution associated with the light transmitted through the biological sample, and prior to reiterating the steps of the reconstruction algorithm until convergence, performing a spectral filtering algorithm that uses the estimate of the extrinsic phase distribution for the current iteration obtained by the other reconstruction algorithms being performed in parallel to obtain a spectrally-filtered estimate for the current iteration of the reconstruction algorithm of the extrinsic phase distribution associated with the light transmitted through the biological sample.

18. The QPI system of claim 14, wherein said at least one respective phasorgram image for each respective wavelength are captured by the multi-wavelength image sensor array in a single-shot acquisition.

19. A quantitative phase imaging (QPI) system for correcting images captured by a camera module of a mobile device for atmospheric aberration, the QPI system comprising:
an adapter configured to be mechanically coupled to a mobile device in optical alignment with a lens of the mobile device, the adapter comprising:
a multi-wavelength light source configured to emit multiple wavelengths of light;
an optically transmissive substrate positioned relative to the light source to ensure that light emitted by the light source is incident on a structure formed in the optically transmissive substrate, the structure comprising at least one of a computer generated hologram (CGH) and a diffractive grating, the structure generating at least one respective phasorgram image for each respective wavelength of light, wherein the lens of the mobile device directs the phasorgram images onto a multi-wavelength image sensor array of the mobile device, the multi-wavelength image sensor array converting the phasorgram images into electrical signals representing the phasorgram images, and
a processor of the mobile device being configured to perform a reconstruction algorithm that processes the electrical signals representing the phasorgram images to obtain a phase distribution estimate of the light transmitted through the lens, the processor being configured to perform an atmospheric aberration correction algorithm that uses the phase distribution estimate to correct images captured by other camera modules of the mobile device to correct for atmospheric aberration in the captured images.

20. The QPI system of claim 19, wherein the multi-wavelength light source comprises at least one of (1) a combination of a natural light source and a plurality of filters that operate on natural light from the natural light source to produce the light of multiple wavelengths and (2) a microscope illumination lamp.
